(19) United States
(12) Patent Application Publication
(10) Pub. No.: US 2024/0419896 A1
(43) Pub. Date: Dec. 19, 2024

(54) METHOD AND APPARATUS FOR DETERMINING QUALITY OF VEHICLE USING TEXT MINING

(71) Applicant: HL MANDO CORPORATION, Gyeonggi-do (KR)

(72) Inventors: Susie CHOI, Gyeonggi-do (KR); Suyeon LEE, Gyeonggi-do (KR); Jaehoon JUNG, Gyeonggi-do (KR); Sangha PARK, Gyeonggi-do (KR)

(21) Appl. No.: 18/416,912

(22) Filed: Jan. 19, 2024

(30) Foreign Application Priority Data
Jun. 14, 2023 (KR) 10-2023-0075878

(51) Int. Cl. G06F 40/279; G06F 40/247; G07C 5/08

(52) U.S. Cl. CPC G06F 40/279; G06F 40/247; G07C 5/0808

(57) ABSTRACT

A method and apparatus for determining a quality of a vehicle using text mining may perform operations including performing, by an electronic apparatus, pre-processing on input data including text, performing, by the electronic apparatus, text mining on the pre-processed input data, labeling, by the electronic apparatus, at least one onomatopoeia or at least one morpheme extracted from the pre-processed input data according to the performing of the text mining, and determining, by the electronic apparatus, a quality of the vehicle based on the labeling.

### CROSS-REFERENCE TO RELATED APPLICATION

This application claims priority to and the benefit of Korean Patent Application No. 10-2023-0075878, filed on Jun. 14, 2023, the disclosures of which is incorporated herein by reference in its entirety.

### TECHNICAL FIELD

The present disclosure generally relates to a method and apparatus for determining a quality of a vehicle using text mining.

### BACKGROUND

Automakers try to prevent vehicle quality problems in advance based on claim data analysis. In particular, the automakers have identified safety issues in advance to prevent customers from campaigning for recalls and stability, and are focusing on minimizing the cost of losses due to the recalls and campaigns. To this end, a claim data management system, which is led by original equipment manufacturing (OEM) for manufactured cars, is being developed.

However, detailed information of the quality problem is currently stored in non-standardized text format, and thus the problem is that core customer complaints are not easy to be identified. For example, since detailed information related to the quality problem is written in a handwriting file or a manually prepared file such as an Excel file, it is inconvenient for engineers to identify customer complaints by individually reviewing the file such as an Excel file.

### SUMMARY

According to an aspect of the present disclosure, there is provided a method and apparatus for determining a quality of a vehicle using text mining, which may analyze claim data through a plurality of algorithms for text mining to identify the quality of the vehicle and label the analysis result to update reference data.

According to an aspect of the present disclosure, there is provided a method for determining a quality of a vehicle using text mining, the method may include: performing, with an electronic apparatus, pre-processing on input data including text, performing, with the electronic apparatus, text mining on the pre-processed input data, performing, with the electronic apparatus, labeling on at least one onomatopoeias or at least one morphemes extracted from the pre-processed input data according to the performing the text mining, and determining, with the electronic apparatus, a quality of the vehicle based on the labeling.

In some embodiments, the method may further include: after the performing the text mining, determining, with the electronic apparatus, the quality of the vehicle based on a default error identified in the pre-processed input data according to the performing the text mining.

In some embodiments, the performing the text mining may include extracting the at least one onomatopoeias from the pre-processed input data.

In some embodiments, the performing the text mining may include extracting the at least one morphemes from the pre-processed input data.

In some embodiments, the performing the labeling may include identifying at least one similar keywords related to the at least one onomatopoeias extracted from pre-stored reference data, and performing labeling with a representative keyword corresponding to the similar keyword.

In some embodiments, the performing the labeling may include generating a set of the extracted at least one morphemes, identifying at least one similar keywords related to the at least one morphemes included in the set of morpheme in the reference data, and performing labeling with a representative keyword corresponding to the similar keyword.

In some embodiments, the method may further include after the performing the labeling, updating, with the electronic apparatus, the reference data with the labeled at least one onomatopoeias or the at least one morphemes.

In some embodiments, the determining the quality of the vehicle based on the default error may include determining the quality of the vehicle based on a warning lamp of the vehicle.

In some embodiments, the determining the quality of the vehicle based on the labeling may include determining the quality of the vehicle based on the representative keyword labeled on the at least one onomatopoeias related to noise generated in the vehicle.

In some embodiments, the determining the quality of the vehicle based on the labeling may include determining the quality of the vehicle related to an operation mode, performance, and others of the vehicle based on the representative keyword labeled on the at least one morphemes.

In some embodiments, the determining a quality of a vehicle using text mining according to an embodiment of the present disclosure may include a controller is configured to perform pre-processing on input data including text, perform text mining on the pre-processed input data to perform labeling on at least one onomatopoeias or at least one morphemes extracted from the input data, and determine a quality of the vehicle based on the labeling, and a displayer for displaying information related to the determined quality of the vehicle.

In some embodiments, the controller may be configured to determine the quality of the vehicle based on a default error identified in the pre-processed input data according to the performing the text mining.

In some embodiments, the controller may be configured to extract the at least one onomatopoeias from the pre-processed input data.

In some embodiments, the controller may be configured to extract the at least one morphemes from the pre-processed input data.

In some embodiments, the controller may be configured to identify at least one similar keywords related to the at least one onomatopoeias extracted from pre-stored reference data, and perform labeling with a representative keyword corresponding to the similar keyword.

In some embodiments, the controller may be configured to generate a set of the extracted at least one morphemes, identify at least one similar keywords related to the at least one morphemes included in the set of morpheme in the reference data, and perform labeling with the representative keyword corresponding to the similar keyword.

In some embodiments, the controller may be configured to update the reference data with the labeled at least one onomatopocias or the at least one morphemes after the performing the labeling.

In some embodiments, the controller may be configured to determine the quality of the vehicle based on a warning lamp of the vehicle.

In some embodiments, the controller may be configured to determine the quality of the vehicle based on the representative keyword labeled on the at least one onomatopoeias related to noise generated in the vehicle.

In some embodiments, the controller may be configured to determine the quality of the vehicle related to an operation mode, performance, and others of the vehicle based on the representative keyword labeled on the at least one morphemes.

As described above, a method and apparatus for determining a quality of a vehicle using text mining according to some embodiments of the present disclosure analyze claim data through a plurality of algorithms for text mining to determine the quality of the vehicle, and label the analysis result to update reference data, thereby eliminating the cumbersome of engineers who need to identify customer complaints by individually review a file such as an Excel file, and gradually improving the accuracy of the analysis result of claim data through updating reference data.

### BRIEF DESCRIPTION OF THE DRAWINGS

FIG. 1 is a block diagram for showing a main configuration of an electronic apparatus for determining a quality of a vehicle using text mining according to an embodiment of the present disclosure.

FIG. 2 is a flowchart for showing a method for determining a quality of a vehicle using text mining according to an embodiment of the present disclosure.

FIG. 3 is a detailed flowchart for illustrating an operation of performing text mining in a method for determining a quality of a vehicle using the text mining according to an embodiment of the present disclosure.

### DETAILED DESCRIPTION

Hereinafter, preferred embodiments according to the present disclosure will be described in detail with reference to the accompanying drawings. The detailed description that will be set forth below in conjunction with the accompanying drawings is intended to describe exemplary embodiments of the invention and is not intended to represent the only embodiments in which the invention may be practiced. In the drawings, parts irrelevant to the description may be omitted to clearly describe the present disclosure, and the same reference numerals may be used for the same or similar components throughout the specification.

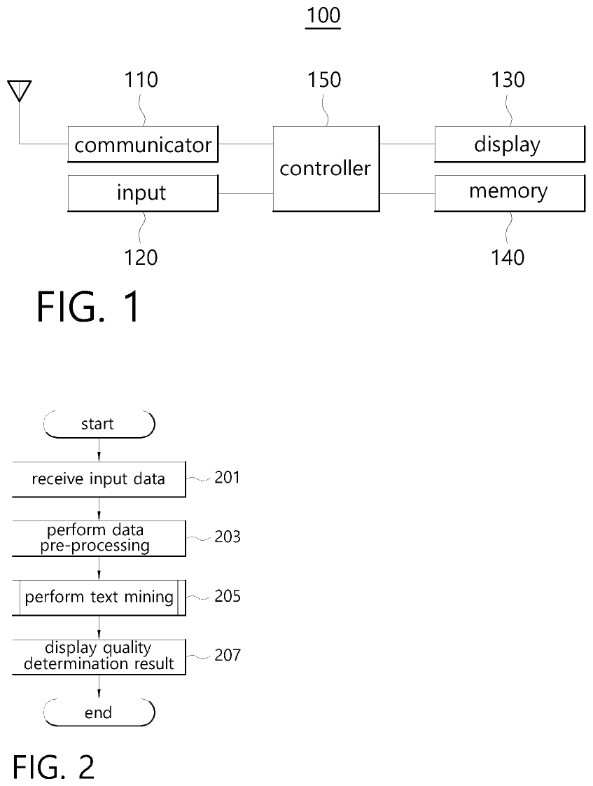

FIG. 1 is a block diagram for showing a main configuration of an electronic apparatus for determining a quality of a vehicle using text mining according to an embodiment of the present disclosure.

Referring to FIG. 1, the electronic apparatus 100 according to the present disclosure may include one or more of a communicator 110, an input 120, a display 130, a memory 140, and a controller 150.

The communicator 110 may be configured to receive input data from an external device (not shown) through communication with the external device. For example, the input data may be claim data in text form and may be data related to the vehicle (e.g. data associated with the operations or quality of the vehicle). To this end, the communicator 110 may perform wireless communication such as long term evolution (LTE) and wireless fidelity (Wi-Fi) with the external device.

The input 120 may be configured to receive an input from a user and generate input data in response to the user's input to the electronic apparatus 100. To this end, the input 120 may include at least one input means. The input 120 may include, for example, but not limited to, a keyboard, a keypad, a dome switch, a touch panel, a touch key, a mouse, a microphone and the like.

The display 130 may be configured to display display data according to operations of the electronic apparatus 100. The display 130 may include, for example, but not limited to, a liquid crystal display (LCD), a light emitting diode (LED) display, an organic LED (OLED) display, a micro electro mechanical systems (MEMS) display, and an electronic paper display. The display 130 may be coupled to the input 120, and may be implemented as a touch screen so that the input 120 can be integrated into the display 130.

The memory 140 may store operation programs for operating the electronic apparatus 100, and may store algorithms serving as a basis for determining the quality of the vehicle by analyzing the input data. More specifically, the memory 140 may store various algorithms including an algorithm of a language model-based chatbot driven by artificial intelligence (AI) technology such as a Chat GPT algorithm (hereinafter, referred to as a first algorithm) and an algorithm for natural language processing such as a Word2Vec algorithm (hereinafter, referred to as a second algorithm) for analyzing input data. For example, the first algorithm uses an AI-powered language model capable of generating human-like text based on context and past conversation and the second algorithm uses a neural network model to learn word associations from a large corpus of text. In addition, the memory 140 may store reference data obtained by mapping a representative keyword, at least one similar keyword at a lower level of the representative keyword, and the quality of the vehicle etc.

The controller 150 may receive claim data implemented in text form (hereinafter, referred to as input data) through the input 120 to determine the quality of the vehicle by an engineer. In addition, the controller 150 may receive the input data from the external device (not shown) through the communicator 110. The controller 150 performs data pre-processing on the input data. For instance, the controller 150 may perform data pre-processing by removing spaces, special characters, and the like from the input data. For example, the controller 150 may comprise one or more hardware processors.

The controller 150 performs text mining on the pre-processed input data. More specifically, the controller 150 calls or uses a plurality of algorithms stored in the memory 140 to analyze the input data having been pre-processed. For example, the text mining may be the process of transforming unstructured text into a structured format to identify meaningful patterns or capture key concepts. As described above, the plurality of algorithms may comprise the first algorithm such as a Chat GPT algorithm and the second algorithm such as a Word2Vec algorithm. The controller 150 performs the analysis of the input data according to a plurality of categories, for example, but not limited to, five categories including noise generated in or by the vehicle, an operation mode of the vehicle, performance of the vehicle, default errors such as warning light (or lamp) of the vehicle, and other errors such as wear, oil leakage, abrasion, small bearing, vibration, cold, hot, upgrade, poor tightening, friction, alignment, side slip, excessive play, steel plate noise and twisted handle.

The controller 150 extracts one or more onomatopocias included in the pre-processed input data using the first algorithm to identify the noise among the five categories. The controller 150 performs labeling on each onomatopoeia. When the onomatopoeias “pibik”, “durrureuk”, and “geiying” are extracted from the pre-processed input data using the first algorithm, the controller 150 may identify at least one similar keyword each related to the extracted onomatopoeias from the pre-stored reference data. For example, similar keywords related to the onomatopoeia of “pibik” may be identified as “beepbeep”, “biik”, “bukbuk”, and “jikjik”, similar keywords related to the onomatopoeia “durrureuk” may be identified as “druleuruk” and “gurureuk”, and similar keywords related to the onomatopoeia of “geiying” may be identified as “geiying”, “jeeing”, “wooiying”, and “uuuing”.

In addition, the controller 150 may separate the extracted onomatopoeia into one or more vowel-consonant units, and apply an edit distance algorithm to identify a similar keyword having the shortest distance from the onomatopoeias separated into the vowel-consonant units among predefined similar keywords as a representative keyword. For example, “pibik” may be identified as the representative keyword related to the onomatopoeia “biik”, “durrureuk” may be identified as a representative keyword related to the onomatopoeia “drulcuruk”, and “geiying” may be identified as a representative keyword related to the onomatopoeia of “geiying”.

The controller 150 identifies a representative keyword corresponding to the identified one or more similar keywords and performs labeling on each of the extracted onomatopoeias. In addition, the controller 150 may update reference data with a representative keyword labeled on each onomatopoeia. Accordingly, the controller 150 may map the identified one or more onomatopoeias to the representative keyword and immediately extract the representative keyword if the same onomatopoeia is identified later.

In addition, the controller 150 generates a set of morphemes by extracting one or more morphemes included in the pre-processed input data in order to identify the operation mode of the vehicle, the performance of the vehicle, and other erorrs among the five categories. The controller 150 performs labeling on each morpheme included in the set of morphemes. The controller 150 may assign a score based on how frequently letters constituting words appear together in a manner of assigning a cohesion score for the pre-processed input data, and may extract words if a minimum frequency of words is set to 5 or more and the cohesion score between two syllables is scored to 5 or more when the words is read from left to right.

The controller 150 identifies one or more similar keywords related to one or more morphemes, identifies a representative keyword corresponding to the identified one or more similar keywords, and performs labeling. For example, one or more similar keywords related to morphemes “in operation” “become interrupted” and “get stiff” extracted from a set of morphemes generated from the pre-processed input data may be identified in the pre-stored reference data. That is, a similar keyword related to the morpheme “in operation” may be “in operation” or “when handling”, a similar keyword related to the morpheme “interrupted” may be “interrupted while snapping” or “interrupted”, and a similar keyword related to the morpheme “get stiff” may be “stiff” or “stiffness”.

In addition, the controller 150 may apply the second algorithm to identify a representative keyword among similar keywords. For example, “in operation” may be identified as a representative keyword related to the morpheme “in operation”, “jammed” may be identified as a representative keyword related to the morpheme “interrupted”, and “stiffness” may be identified as a representative keyword related to the morpheme “get stiff”.

Accordingly, the controller 150 labels each morpheme with the identified representative keyword. In addition, the controller 150 may update the reference data with a representative keyword labeled on each morpheme. Accordingly, the controller 150 may map the identified one or more morphemes to the representative keyword and immediately extract the representative keyword if the same morpheme is identified later.

The controller 150 may perform labeling if a default error is identified in the pre-processed input data. For example, if a warning light (or lamp) code, etc. identified in the preprocessed input data is confirmed or if a keyword, such as turning on a warning light (or lamp) or turning on a phrase, etc. is included in a sentence, the controller 150 may perform labeling by extracting it. The controller 150 may label the pre-processed input data with C2401 and may identify a default error of the vehicle corresponding to the corresponding warning light (or lamp) code.

When at least one of onomatopoeias, morpheme, and default error is identified in the pre-processed input data, the controller 150 may determine a part in which a problem occurs in the quality of the vehicle by identifying labeling. The controller 150 displays the quality determination result of the vehicle on the display 130.

FIG. 2 is a flowchart for illustrating a method for determining a quality of a vehicle using text mining according to an embodiment of the present disclosure.

Referring to FIG. 2 together with FIG. 1, in Step 201, the controller or processor 150 may receive claim data implemented in text form (hereinafter, referred to as input data) through the input 120 to determine the quality of the vehicle by an engineer. In addition, the controller 150 may receive input data from an external device (not shown) through the communicator 110.

In Step 203, the controller 150 performs data pre-processing on the input data received at Step 201. For example, the controller 150 may perform the data pre-processing by removing spaces, special characters, and the like from the input data.

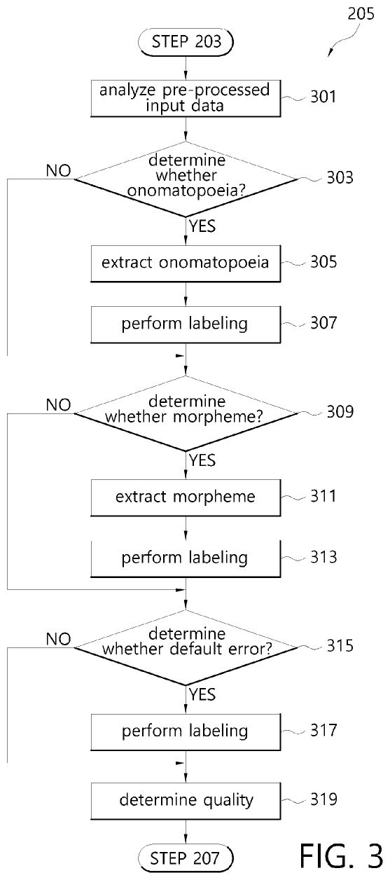

In Step 205, the controller 150 performs text mining on the pre-processed input data. This will be described in more detail with reference to FIG. 3 below.

FIG. 3 is a detailed flowchart for illustrating an operation of performing text mining in a method for determining a quality of a vehicle using the text mining according to an embodiment of the present disclosure.

Referring to FIG. 3 together with FIG. 1, in Step 301, the controller 150 analyzes the input data pre-processed in Step 205 of FIG. 2. To this end, the controller 150 may analyze the input data by calling or using a plurality of algorithms stored in the memory 140, and the plurality of algorithms may be an algorithm of a language model-based chatbot driven by artificial intelligence (AI) technology such as a Chat GPT algorithm (hereinafter, referred to as a first algorithm) and an algorithm for natural language processing such as a Word2Vec algorithm (hereinafter, referred to as a second algorithm). For example, the first algorithm uses an AI-powered language model capable of generating human-like text based on context and past conversation and the second algorithm uses a neural network model to learn word associations from a large corpus of text. The controller 150 analyzes the input data according to five categories including noise generated in or by the vehicle, an operation mode of the vehicle, performance of the vehicle, default errors such as warnings of the vehicle, and other errors such as wear, oil leakage, abrasion, small bearing, vibration, cold, hot, upgrade, poor tightening, friction, alignment, side slip, excessive play, steel plate noise and twisted handle.

In Step 303, the controller 150 determines whether the pre-processed input data includes one or more onomatopoeias using the first algorithm to identify the noise among the five categories. If it is determined that the pre-processed input data includes at least one onomatopoeia in Step 303, the controller 150 performs Step 305. In Step 305, the controller 150 extracts one or more onomatopoeias included in the pre-processed input data and performs Step 307. On the contrary, if the pre-processed input data does not include any onomatopoeia, the controller 150 performs Step 309 without performing Steps 305 and 307.

In Step 307, the controller 150 performs labeling on each onomatopoeia. For example, when the onomatopoeias “pibik”, “durrureuk”, and “geiying” are extracted from the pre-processed input data using the first algorithm as shown in Table 1, the controller 150 may identify one or more similar keywords related to each of the extracted onomatopoeias in or from the pre-stored reference. For instance, similar keywords related to the onomatopoeia of “pibik” may be identified as “beepbeep”, “biik”, “bukbuk”, and “jikjik”, similar keywords related to the onomatopoeia “durrureuk” may be identified as “druleuruk” and “gurureuk”, and similar keywords related to the onomatopoeia of “geiying” may be identified as “geiying”, “jeeing”, “wooiying”, and “uuuing”.

In addition, the controller 150 may separate the extracted onomatopoeia into one or more vowel-consonant units, and apply an edit distance algorithm to identify a similar keyword having the shortest distance from the onomatopoeia separated into one or more vowel-consonant units among predefined similar keywords as a representative keyword. For example, “pibik” may be identified as the representative keyword related to the onomatopoeia “biik”, “durrureuk” may be identified as a representative keyword related to the onomatopoeia “druleuruk”, and “geiying” may be identified as a representative keyword related to the onomatopoeia of “geiying”.

The controller 150 identifies a representative keyword corresponding to the identified one or more similar keywords and performs labeling on the extracted onomatopoeia. That is, the controller 150 may update the reference data with the identified representative keyword if the representative keyword is the same as the label. Accordingly, the controller 150 may map the identified one or more onomatopoeias to the representative keyword and immediately extract the representative keyword if the same onomatopoeia is identified later.

TABLE 1

| 1st | | | |
|---|---|---|---|
| Algorithm | | | |
| (GPT) | Similar keywords in | Edit distance | |
| extraction | reference data | application result | Labeling |
| pibik | beepbeep, biik, bukbuk, jikjik | biik | biik |
| durrureuk | druleuruk, gurureuk | druleuruk | druleuruk |
| geiying | geiying, jeeing, wooiying, | geiying | geiying |
| | uuuing | | |

In Step 309, the controller 150 determines whether at least one morpheme is included in the pre-processed input data in order to identify the operation mode of the vehicle, the performance of the vehicle, and other erorrs among the five categories. If it is determined in Step 309 that the pre-processed input data includes at least one morpheme, in Step 311, the controller 150 may extract one or more morphemes included in the pre-processed input data. For example, “in operation” may be identified as a representative keyword related to the morpheme “in operation”, “jammed” may be identified as a representative keyword related to the morpheme “interrupted”, and “stiffness” may be identified as a representative keyword related to the morpheme “get stiff”. The controller 150 generates a set of morphemes and performs Step 313. On the contrary, if the pre-processed input data does not include any morpheme, the controller 150 performs Step 315 without performing Steps 311 and 313.

In Step 313, the controller 150 performs labeling on each morpheme. An example of the set of morphemes generated based on the pre-processed input data is shown in Table 2 below. In this case, the controller 150 may assign a score based on how frequently letters constituting words appear together in a manner of assigning a cohesion score for the pre-processed input data, and may extract words if a minimum frequency of words is set to 5 or more and the cohesion score between two syllables is scored to 5 or more when the words is read from left to right.

TABLE 2

| Pro-processed input data | Set of morphemes (tokenizer) |
|---|---|
| There is no housing abnormality, when | No housing handle abnormality |
| operating the steering handle | during operation |
| When steering wheel turned to the right, | Feeling of being interrupted |
| it felt like it feels like it is | while snapping |
| interrupted while snapping and it came | |
| into garage for checking | |
| Steering wheel gets stiff when vehicle | Steering wheel getting stiff in |
| turns right | turning right |

The controller 150 identifies one or more similar keywords related to one or more morphemes, identifies a representative keyword corresponding to the identified one or more similar keywords, and performs labeling. The controller 150 may update the reference data with the identified representative keyword if the representative keyword is the same as the label.

More specifically, the controller 150 identifies a representative keyword corresponding to the identified one or more similar keywords and performs labeling on the extracted onomatopoeia as shown in Table 3 below. That is, the controller 150 may update the reference data with the identified representative keyword if the representative keyword is the same as the label. Accordingly, the controller 150 may map the identified one or more onomatopoeias to the representative keyword and immediately extract the representative keyword if the same onomatopoeia is identified later.

One or more similar keywords related to morphemes “in operation” “disconnected,” and “get stiff” extracted from a set of morphemes may be identified in the pre-stored reference data. For example, a similar keyword related to the morpheme “in operation” may be “in operation” or “when handling”, a similar keyword related to the morpheme “interrupted” may be “interrupted while snapping” or “interrupted”, and a similar keyword related to the morpheme “get stiff” may be “stiff” or “stiffness”.

In addition, the controller 150 may apply the second algorithm to identify a representative keyword among similar keywords. For example, “in operation” may be identified as a representative keyword related to the morpheme “in operation”, “jammed” may be identified as a representative keyword related to the morpheme “interrupted”, and “stiff” may be identified as a representative keyword related to the morpheme “get stiff”.

Accordingly, the controller 150 labels each morpheme with the identified representative keyword. In addition, the controller 150 may update the reference data with a representative keyword labeled on each morpheme. Accordingly, the controller 150 may map the identified one or more morphemes to the representative keyword and immediately extract the representative keyword if the same morpheme is identified later.

TABLE 3

| | | Similar | 2nd algorithm | |
|---|---|---|---|---|
| | Set of | keywords in | (Word2vec) | |
| | morphemes | reference | application | |
| Category | (tokenizer) | data | result | Labeling |
| Operation | no housing | in operation, | in | in |
| mode | handle | and when | operation | operation |
| | abnormality | handing | | |
| | during | | | |
| | operation | | | |
| Performance | feeling of | interrupted | jammed | jammed |
| | being | while | | |
| | interrupted | snapping, | | |
| | while snapping | and | | |
| | | interrupted | | |
| Other | steering wheel | stiff, | stiff | stiff |
| erorrs | getting stiff in | stiffness | | |
| | turning right | | | |

Then, in Step 315, the controller 150 analyzes the pre-processed input data in order to identify a default error among the five categories. If the default error is identified in the pre-processed input data, the controller 150 may perform labeling in Step 317. For example, as shown in Table 4 below, if the warning light (or lamp) code, etc. identified in the preprocessed input data is found or confirmed or if a keyword, such as turning on a warning light (or lamp) or turning on a phrase, etc. included in a sentence, the controller 150 may perform labeling by extracting it. That is, as shown in Table 4 below, when the warning light (or lamp) code such as C2401 is identified in the pre-processed input data, the controller 150 may label the pre-processed input data with C2401 and may identify a default error of the vehicle corresponding to the corresponding warning light (or lamp) code.

TABLE 4

| | Extracted | |
|---|---|---|
| Pre-processed input data | result | Labeling |
| After starting the vehicle, the steering wheel | C2401 | C2401 |
| became heavy intermittently, so it is inspected at | | |
| garage. | | |
| When checking the fault code C2401, motor | | |
| position sensor error is checked, and power and | | |
| connector wiring are checked. | | |
| Nothing unusual | | |
| Column exchange is progressed because it is | | |
| assumed to be abnormal inside column | | |

If the default error is not identified in the pre-processed input data, the controller 150 may perform Step 319 to determine the quality of the vehicle. For example, the controller 150 may identify the quality of the vehicle based on the labeling performed in Step 307, 313 or 317. For instance, when all of the onomatopoeia, the morpheme and the default error are not identified in the pre-processed input data, the controller 150 may determine that the vehicle does not have a quality problem, and when at least one of the onomatopoeias, the morpheme, and the default error is identified in the pre-processed input data, the controller 150 may determine a part of the vehicle in which a problem occurs in the quality of the vehicle by identifying the labeling.

Subsequently, in Step 207, the controller 150 displays the quality determination result identified in Step 319 of FIG. 3 on the display 130.

The embodiments of the present disclosure disclosed in the specification and the drawings are merely provided to easily describe the technical content of the present disclosure and to help understand the present disclosure, and are not intended to limit the scope of the present disclosure. Accordingly, it should be understood that the scope of the present disclosure is interpreted as including all changes or modifications derived based on the technical idea of the present disclosure in addition to the embodiments disclosed herein.

What is claimed is:

1. A method implemented by one or more hardware processors, the method comprising:
pre-processing input data including text and related to a vehicle;
performing text mining on the pre-processed input data;
labeling one or more onomatopoeias or one or more morphemes extracted from the pre-processed input data according to the text mining; and
determining a quality of the vehicle based on the labeling of the one or more onomatopoeias or the one or more morphemes extracted from the pre-processed input data according to the text mining.

2. The method of claim 1, further comprising:
after the performing of the text mining, determining the quality of the vehicle based on a default error identified in the pre-processed input data according to the text mining.

3. The method of claim 2, wherein the performing of the text mining comprises:
extracting the one or more onomatopoeias from the pre-processed input data.

4. The method of claim 3, wherein the performing of the text mining comprises:
extracting the one or more morphemes from the pre-processed input data.

5. The method of claim 4, wherein the labeling of the one or more onomatopoeias or the one or more morphemes comprises:
identifying one or more similar keywords associated with the one or more onomatopoeias extracted from pre-stored reference data; and
labeling the one or more onomatopoeias with a representative keyword corresponding to the one or more similar keywords associated with the one or more onomatopoeias extracted from the pre-stored reference data.

6. The method of claim 5, wherein the labeling of the one or more onomatopoeias or the one or more morphemes comprises:
generating a set of the one or more morphemes extracted from the pre-processed input data by the text mining;
identifying one or more similar keywords, related to the one or more morphemes included in the set of the extracted one or more morphemes, in the pre-stored reference data; and
labeling the one or more morphemes with a representative keyword corresponding to the one or more similar keywords related to the one or more morphemes included in the set of the extracted one or more morphemes.

7. The method of claim 6, further comprising:
after the labeling of the one or more onomatopoeias or the one or more morphemes, updating the pre-stored reference data with the labeled one or more onomatopoeias or the labeled one or more morphemes.

8. The method of claim 2, wherein the determining of the quality of the vehicle based on the default error comprises:
determining the quality of the vehicle based on a warning light of the vehicle.

9. The method of claim 7, wherein the determining of the quality of the vehicle based on the labeling of the one or more onomatopoeias or the one or more morphemes comprises:
determining the quality of the vehicle based on the representative keyword labeled on the one or more onomatopoeias associated with noise generated in or by the vehicle.

10. The method of claim 7, wherein the determining of the quality of the vehicle based on the labeling of the one or more onomatopoeias or the one or more morphemes comprises:
determining the quality of the vehicle related to an operation mode, performance, and other errors included oil leakage of the vehicle based on the representative keyword labeled on the one or more morphemes.

11. A apparatus for determining a quality of a vehicle using text mining, the apparatus comprising:
a memory; and
a processor that, when executing computer executable instructions stored in the memory, is configured to:
pre-process input data including text and related to a vehicle,
perform text mining on the pre-processed input data,
label one or more onomatopoeias or one or more morphemes extracted from the pre-processed input data according to the text mining, and
determine a quality of the vehicle based on the labeling of the one or more onomatopoeias or the one or more morphemes extracted from the pre-processed input data according to the text mining; and
a display configured to display information related to the determined quality of the vehicle.

12. The apparatus of claim 11, wherein the processor is configured to:
determine the quality of the vehicle based on a default error identified in the pre-processed input data according to the text mining.

13. The apparatus of claim 12, wherein the processor is configured to:
extract the one or more onomatopoeias from the pre-processed input data by the text mining.

14. The apparatus of claim 13, wherein the processor is configured to:
extract the one or more morphemes from the pre-processed input data by the text mining.

15. The apparatus of claim 14, wherein the processor is configured to:
identify one or more similar keywords associated with the one or more onomatopoeias extracted from pre-stored reference data, and
labeling the one or more onomatopoeias with a representative keyword corresponding to the one or more similar keywords associated with the one or more onomatopoeias extracted from the pre-stored reference data.

16. The apparatus of claim 15, wherein the processor is configured to:
generate a set of the one or more morphemes extracted from the pre-processed input data by the text mining,
identify one or more similar keywords related to the one or more morphemes included in the set of the extracted one or more morpheme, in the pre-stored reference data, and
label the one or more morphemes with the representative keyword corresponding to the one or more similar keywords related to the one or more morphemes included in the set of the extracted one or more morphemes.

17. The apparatus of claim 16, wherein the controller is configured to:
after the labeling of the one or more onomatopoeias or the one or more morphemes, update the pre-stored reference data with the labeled one or more onomatopoeias or the labeled one or more morphemes.

18. The apparatus of claim 12, wherein the controller is configured to:
determine the quality of the vehicle based on a warning light of the vehicle.

19. The apparatus of claim 17, wherein the controller is configured to:
determine the quality of the vehicle based on the representative keyword labeled on the one or more onomatopoeias associated with noise generated in or by the vehicle.

20. The apparatus of claim 17, wherein the controller is configured to:
determine the quality of the vehicle related to an operation mode, performance, and other errors included oil leakage of the vehicle based on the representative keyword labeled on the one or more morphemes.
